(19) United States
(12) Patent Application Publication
(10) Pub. No.: US 2008/0245626 A1
(43) Pub. Date: Oct. 9, 2008

(54) Electromagnetic Retarder For a Motor Vehicle

(75) Inventor: Zeng Gang Liu, Maurecourt (FR)

Correspondence Address: MATTHEW R. JENKINS, ESQ., 2310 FAR HILLS BUILDING, DAYTON, OH, 45419, US

(73) Assignee: TELMA, Saint-Ouen-L'Aumone (FR)

(21) Appl. No.: 10/599,189

(22) PCT Filed: Mar. 24, 2005
(86) PCT No.: PCT/FR2005/000714

§ 371 Date: Sep. 22, 2006

(30) Foreign Application Priority Data
Mar. 24, 2004 (FR) 04 03045

(51) Int. Cl. H02K 49/04

(52) U.S. Cl. 188/161

(57) ABSTRACT

An electromagnetic retarder used to reduce the speed of a rotating machine. This retarder comprises a stator through which a first shaft passes and a rotor which is assembled with the first shaft. The first shaft has a first end and a second end which are axially opposite and which can be coupled respectively to a second shaft which is linked to a motive source and a third shaft which is linked to a load. The first shaft is configured, at least at one of the two ends thereof, in such a way that it can be respectively coupled to the first or second shaft in an axially sliding manner.

### BACKGROUND OF THE INVENTION

1. Field of the Invention

The invention relates to an electromagnetic retarder used to reduce the speed of a rotating machine, to a motor vehicle and to a test bench equipped with such a retarder, as well as a method of installing such a retarder in a motor vehicle.

The present invention relates to an electromagnetic retarder intended to be used in a motor vehicle as an auxiliary braking system or on a test bench as the variable load of an engine under test on this bench.

2. Description of the Related Art

To decelerate motor vehicles presenting a great inertia related to their weight and to the speed at which they move, it is necessary to use auxiliary braking, which is an endurance braking system, because traditional braking with the service brake of the vehicles, using shoes or brake pads rubbing against a disc of a wheel hub, is not always sufficient to reliably ensure the deceleration, that is to say the braking of these vehicles.

Indeed, with the friction of the service brakes being the principle of their operation, the braking reliability depends on the effectiveness of the friction, for example, of the shoes against a disc. Moreover, with the friction generating heat, and too great a heat build-up of the shoes and the disc reducing the braking effectiveness, the use of the service brake is excluded since endurance braking is necessary, for example on a downhill road. In addition to this restriction, very frequent use of the service brake involves fairly substantial consumption of brake shoes and hours of maintenance to replace the worn shoes.

In contrast to friction brakes, electromagnetic retarders, used typically as auxiliary endurance and braking systems, are components almost without wear.

Indeed, their design and their operation are based on the principle of eddy currents, thus an electromagnetic phenomenon requiring the absence of physical contact and thus of friction arising between the parts.

Therefore an electromagnetic retarder, such as those described in FR-2 440 110 and FR 2 577 357, comprises at least a stator and at least a rotor. The stator is passed through by a shaft and the rotor is assembled with the shaft in order to present an internal cylindrical face in the vicinity of an external cylindrical face of the stator and with a thin air-gap between the rotor and the stator. The rotor and the stator are assembled co-axially and on two planes parallel to one another. According to the type of electromagnetic retarder selected, it is either the rotor or the stator, which comprises an even number of electric coils of alternate polarity and which is able to generate a magnetic field in a ferromagnetic part of the stator, when the rotor is the inductor, and vice a versa. The generation of the eddy currents being accompanied by heat build-up of the rotor by Joule effect resulting in a loss of energy, it is generally necessary to cool the electromagnetic retarder by means of a gaseous fluid or liquid. In the case of air cooling, the retarder comprises a fan.

To obtain the typical operation of an electromagnetic retarder, the stator comprises an inductor formed by electric coils, able to generate a magnetic field in a ferromagnetic part of the rotor constituting the armature. When the rotor is made to rotate, the metal pieces of the rotor cut induction lines of the magnetic field generated by the inductor coils. These result in the nascent currents induced in the ferromagnetic part. These induced currents, because of the low electric resistance presented to them in this ferromagnetic part, have a considerable intensity and, according to Lenz's law, flow in such a direction that, by their effects, they oppose the change in magnetic flux, which dictates the direction, namely the rotational movement of the rotor. The stronger the magnetic field generated by the inductor coils, the stronger the induced currents, known as eddy currents, which in turn generate an inversely strong magnetic field having the effect of decelerating, and finally of braking the rotor more quickly.

The electromagnetic retarder of the invention will be explained below in connection with a motor vehicle for which it constitutes an auxiliary endurance and braking system. However, the general explanations and description of the embodiments of an electromagnetic retarder of the invention, by analogy, can be transposed to other applications, for example the use of an electromagnetic retarder in a test bench for engines or rotating machines where the braking energy consumed by the retarder can be regulated and provides a measure for the horsepower of the engine. Indeed, the operation of the retarder can be varied and regulated very easily, whereas the inertia of a rotating mass, driven by the engine under test, cannot.

In the same way reference will be made below in a general way to a motor vehicle without specific distinction being made between a truck, bus or any other type of vehicle which is intended to be equipped with an electromagnetic retarder to render it usable in particular applications, in particular on routes with downhill sections.

Electromagnetic retarders mainly belong to one of the following three types of retarder, namely axial type retarders cooled by air and intended to be fitted to a propshaft, Focal (registered trademark) type retarders, also cooled by air and intended to be fitted at the entry of a final drive of a vehicle, that is to say the transmission part driving a wheel axle, or at the exit of a gearbox, and Hydral (registered trademark) type retarders comprising a cooling system with circulating fluid.

Apart from the Hydral type retarders characterized by their mode of cooling, the retarders are primarily characterized by the design of the mechanism on which they are to be fitted and by the type of connection or attachment resulting from this.

Indeed, each of the three assembly sites of an electromagnetic retarder detailed above in relation to the type of suitable retarder, has its own constraints, which must be taken into account in the design and improvement of the retarders.

When an electromagnetic retarder is fitted at the exit of a gearbox or at the entry of a final drive, the arrangement thus obtained must be as compact as possible, that is to say in particular as short as possible in the axial direction, but nevertheless must retain sufficient dynamic freedom in the axial and crosswise directions to compensate the forces which the various movements of each of the two assembled parts generate. Hence the need to use cardan joints. At the same time a vehicle not designed originally to be equipped with a retarder cannot always be modified to be equipped with such without carrying out fairly substantial modifications to the floor or chassis of the vehicle.

In the same way fitting the electromagnetic retarder to the final drive or the gearbox is only sound if the casing of the gearbox or the final drive is strong enough to support the weight and in particular the dynamic forces such as the vibrations of the retarder. Since the casings of these parts are generally made of formable material, for example cast iron or aluminum, the retarder is often fitted mainly on the chassis of the motor vehicle to relieve the casing and only as an auxiliary fitting, if absolutely necessary, on the casing itself.

When the electromagnetic retarder is assembled on a propshaft connecting the combustion engine via a gearbox and in particular via an output shaft of the latter, to driving wheels of a traction axle, care must be taken that the electromagnetic retarder is not positioned too close to parts containing synthetic material, because during fairly heavy and very heavy braking the retarder releases quite substantial heat which is often added to that dispersed by the exhaust pipes. The heat from the single retarder could endanger plastic parts, for example a fuel tank, if the retarder is not arranged at a sufficient distance from such a part. However, for example on a compact commercial vehicle, it can be difficult to position the retarder so that it is not too close to the petrol tank of the vehicle.

In addition, according to another practical aspect regarding the design of the vehicles, an electromagnetic retarder can appear to be a cumbersome object, even if it is mounted on a propshaft linking the gearbox to the traction axle. Indeed, with the retarder cutting the propshaft in two, two extra cardan joints are necessary to connect the retarder to these two sections of the propshaft. The cardan joints, also rendering the possibility of preventing the retarder becoming mechanically hyperstatic, comprise the flanges necessary for their fitting on the parts which they link up. However, this involves both additional production volumes for the design of the vehicle chassis and extra weight for the vehicle, which at the same time reduces the payload of the latter.

Lastly, but without being restrictive in stating the problems presented by electromagnetic retarders used to date, the question of retrofitting a retarder to a propshaft of a vehicle already in service should be considered. For this reason retarders currently used comprise a fairly substantial number of parts because of their mode of fitting by flanges with or without jaw ends of a cardan joint. Consequently, retrofitting a motor vehicle with an electromagnetic retarder is often a fairly onerous operation in terms of assembly time consumed.

### SUMMARY OF THE INVENTION

An object of the present invention is to overcome the various problems stated above.

More particularly, the object of the present invention is to propose an electromagnetic retarder which is more compact and, if possible lighter, capable of rendering the electromagnetic retarder easier to integrate in existing vehicle architectures and as a result avoiding development costs for new chassis or floors.

The object of the invention is achieved with an electromagnetic retarder to reduce the speed of a rotating machine in which the retarder comprises a stator passed through by a first shaft having a first and a second end which are axially opposite and intended to be coupled to at least a second shaft which is linked to a motive source and a rotor linked in rotation with the first shaft in order to present an internal cylindrical face in the vicinity of an external cylindrical face of the stator with a thin air-gap between the stator and the rotor.

In accordance with the invention, the first shaft is configured at least one of its two ends in such a way that it can be coupled to the shaft coming from the motive source or possibly also to a shaft linked to the load, in an axially sliding manner.

According to the embodiment selected, the two ends of the first shaft can be configured so that one of the two ends receives the corresponding shaft, namely the second shaft linked to the motive source or the third shaft linked to a load, by hafting, and so that the other of the two ends of the first shaft is received in the remaining shaft by hafting. As an example: the first of the two ends of the first shaft is configured in such a way that it can receive the second shaft by hafting, whereas the second of the two ends of the first shaft is configured in such a way that it can be fitted in the third shaft by hafting.

The inverse configuration of the two ends of the first shaft, compared with the above example, just as a configuration according to which the two ends of the first shaft are configured in the same way, also lies within the scope of the present invention.

The present invention in addition also relates to the following features, considered separately or regarding all their technically feasible combinations:
The axial retarders in any event and the Focal retarders in the majority of cases, are designed to be arranged in a powertrain and for this purpose are equipped with a first shaft whose two ends are intended to be coupled to a shaft, respectively a second shaft linked to a motive source and a third shaft linked to a load such as a traction axle. However, it is also conceivable, without departing from the scope of the present invention, that the retarder is designed to be fitted to a rear axle of a motor vehicle, on the opposite side to the arrival of a propshaft. In this case, the first shaft of the retarder shall be intended to be coupled only to the second shaft, linked to a motive source, but not to a third shaft. For such an application, the first shaft therefore only needs to be configured at one of its two ends for an axially sliding coupling.
If the retarder is fitted behind the rear axle of a motor vehicle, the single rotor is mounted on the opposite side to the final drive.

The object of the invention is also achieved with a motor vehicle and a test bench equipped with such a retarder, as well as a method for installing such a retarder in a motor vehicle.

The method for installing a retarder according to the invention in a motor vehicle more particularly relates to the modification of a vehicle without a retarder into a vehicle with a retarder, as will be described below in detail.

These and other objects and advantages of the invention will be apparent from the following description, the accompanying drawings and the appended claims.

### BRIEF DESCRIPTION OF THE ACCOMPANYING DRAWINGS

Other features and advantages of the present invention will become evident from the description below of two embodiments of a retarder according to the invention, this illustrative and by no means restrictive description being written with reference to the drawings, wherein:

FIG. 1 shows a motor vehicle with the three principal sites for a retarder;

FIG. 2 shows, diagramatically, a retarder according to a first embodiment of the invention, integrated in a powertrain formed mainly by a propshaft in two sections;

FIG. 3 shows an axial retarder installed in a propshaft according to a technique prior to the invention;

FIG. 4 shows the retarder in FIG. 2 in greater detail;

FIG. 5 shows an axial retarder according to the first embodiment of the invention, but with a traditional flange on the output side of the retarder;

FIG. 6 shows a Focal retarder according to a second embodiment of the invention;

FIG. 7 shows a first alternative of the retarder in FIG. 6;

FIG. 8 shows another alternative of the retarder in FIG. 6; and

FIG. 9 shows a retarder similar to that in FIG. 7, but with an auxiliary fixing on a gearbox casing.

### DESCRIPTION OF TWO PREFERRED EMBODIMENTS OF THE INVENTION

FIG. 1 illustrates, diagramatically, in side view, a motor vehicle in the form of a truck with indication of the three preferred sites R1, R2 and R3 of a retarder in the powertrain between an engine M and an axle carrying driving wheels RM. According to this embodiment the engine M transmits a motive force to a gearbox B constituting, within the scope of the present invention, a motive source intended to be coupled to a retarder according to the invention, through which the motive force is transmitted, if necessary in a reduced way, to the driving wheels constituting a load driven in rotation by the motive source.

In this diagramatic illustration, reference R1 indicates the first of the three preferred positions of a retarder according to the invention, that is to say the focal assembly of a retarder at the exit of the gearbox B. The retarder is fitted directly to the gearbox B, that is to say the output shaft of the gearbox B is coupled to the input of the retarder and the output of the retarder is coupled to a propshaft in two sections A1, A2 connected between these.

The fitting of an electromagnetic retarder in position R2 is an axial assembly where the retarder is connected on both sides, that is to say at the entry and at the exit, respectively to a propshaft AI or A2, shaft AI coming from the motive source B and shaft A2 going to driving wheels RM.

The position R3 is that where a retarder according to the invention is fitted at the entry of a final drive of the vehicle, that is to say at the entry of the differential axle carrying driving wheels RM.

If a retarder according to the invention has to be mounted in position R1 or position R3, a Focal retarder will preferably be chosen, whereas in site R2, an axial retarder will be fitted.

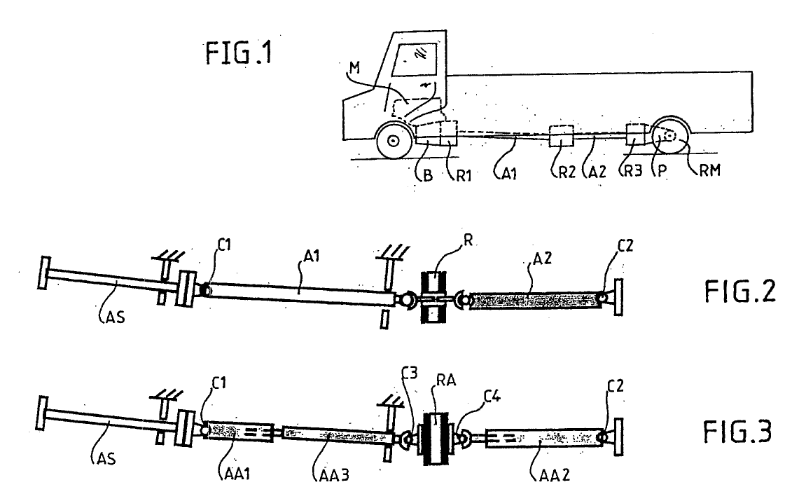

FIG. 2 illustrates, diagramatically, the fitting of an electromagnetic retarder according to the invention in a layout corresponding to the position R2 in FIG. 1. The retarder R is of the axial type and is integrated in a powertrain according to which the motive force generated by an engine M is transmitted to the exit of a gearbox B represented by its output shaft AS which transmits the motive force by means of an articulated flange with cardan joint CI and a first propshaft AI through the retarder R to a second propshaft A2 and by means of a flange with cardan joint C2 to the final drive P. In this powertrain, propshafts AI, A2, output shaft AS of the gearbox and retarder R are suspended on the chassis as illustrated partially in FIG. 2.

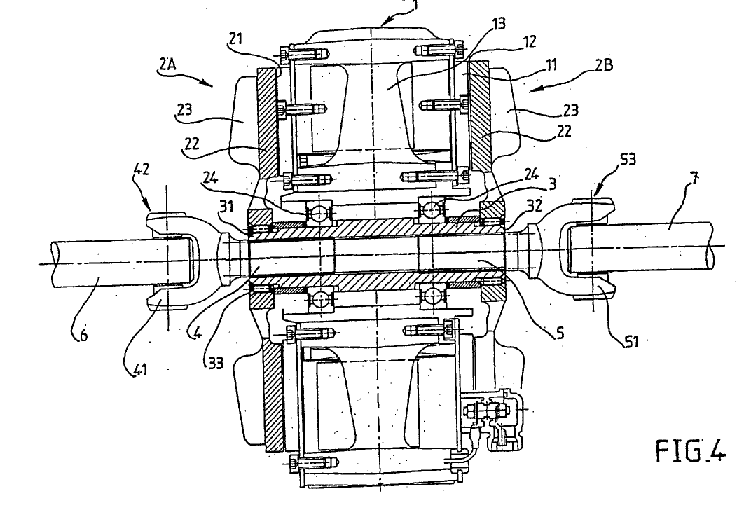

For the purposes of comparison, FIG. 3 shows the layout of a retarder RA dating prior to the invention and having, respectively on the entry side and the exit side of the retarder R, flanges C3, C4 with corresponding cardan joint. The powertrain of the motive force coming from the output shaft AS, passing through a flange with cardan joint C1, is transmitted via a first propshaft AA1 which cooperates in a sliding manner with a second propshaft AA3 mounted by the flange with cardan joint C3 on the retarder RA. The output of retarder RA transmits the motive force, possibly in a reduced way, by the flange with cardan joint C4 to a third axially sliding propshaft AA2 mounted on the output of the retarder RA and, by means of the flange with cardan joint C2, to the final drive P of the motor vehicle.

The principal advantage of the layout according to the invention, illustrated in FIG. 2 and explained in greater detail with reference to FIG. 4 and following, relative to the layout prior to the invention, illustrated in FIG. 3, consists in the substantial reduction of the numbers of parts necessary for a powertrain comprising a retarder.

Indeed, as is clear by juxtaposing the two FIGS. 2 and 3 showing the layouts respectively after and prior to the invention, the powertrain using a retarder according to the invention only comprises two propshafts, AI and A2, whereas the line without the benefit of the invention requires three propshafts, AA1, AA3 and AA2 respectively.

This advantage is obtained by integrating the function of the sliding motion of the propshaft in the shaft of the retarder.

With reference to FIGS. 2 and 3 this means that the axially sliding connections between shafts AA1 and AA3 on the one hand, and between cardan joint C4 and shaft AA2, on the other hand, are integrated in the retarder R, as will be explained below with reference to FIGS. 4 to 9.

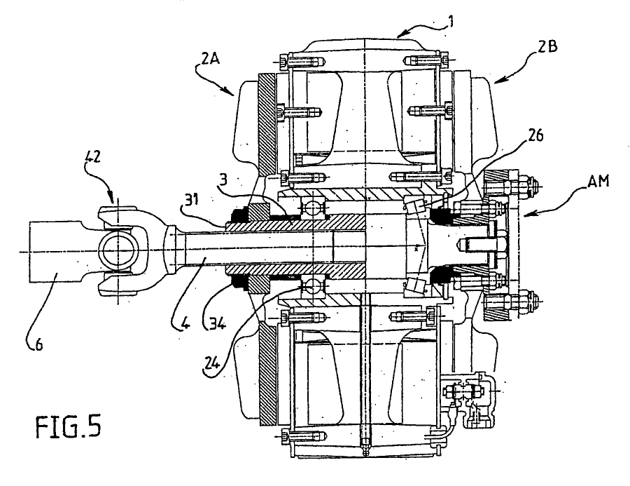

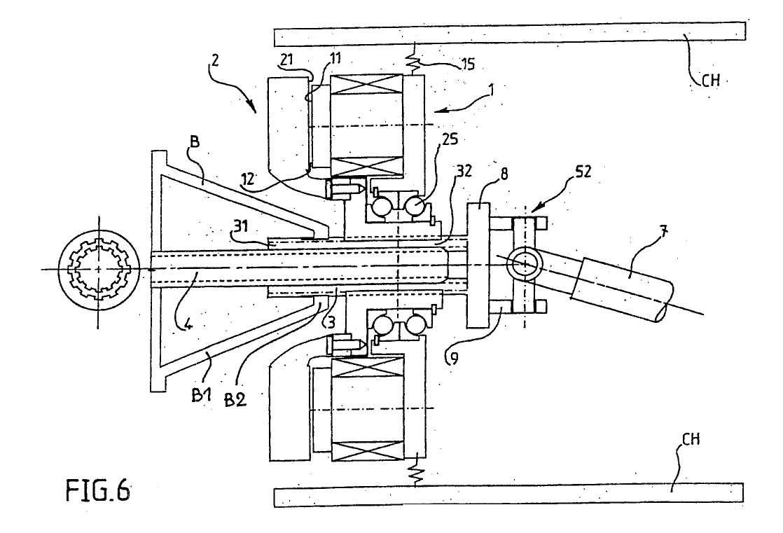

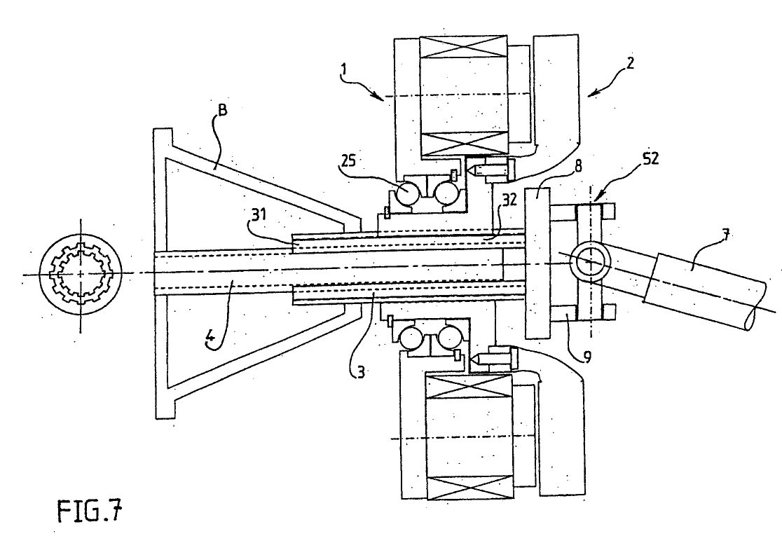

An electromagnetic retarder according to the invention comprises a stator 1 passed through by a first shaft 3 having a first end 31 and a second end 32. The first and second ends 31, 32 are axially opposite and intended to be coupled respectively to a second shaft 4 which is linked to a motive source 6, for example the output shaft of a gearbox, and to a third shaft 5 which is linked to a load, for example via a propshaft 7 to an axle comprising the driving wheels. The retarder according to the invention also comprises a rotor 2 including two discs 2A and 2B in the embodiments illustrated in FIGS. 4 and 5, and a single disc 2 in the embodiments illustrated in FIGS. 6 to 9. With rotors 2A and 2B being identical, but only assembled in the opposite position relative to one another, they are commonly referenced below as rotor 2. Each rotor 2 is provided with cooling ribs 23.

Rotor 2 is assembled with first shaft 3 in order to present an internal cylindrical face 21 in the vicinity of an external cylindrical face 11 of stator 1 with a thin air-gap 12 between stator 1 and rotor 2. Rotor 2 is mounted on stator 1 by means of ball bearings 24.

To obtain the typical operation of an electromagnetic retarder, stator 1 comprises an inductor 13 formed by electric coils, able to generate a magnetic field in an annular ferromagnetic part 22 of rotor 2, said annular ferromagnetic part 22 constituting the armature. When rotor 2 is made to rotate, the metal pieces of rotor 2 cut induction lines of the magnetic field generated by the coils of inductor 13. These result in the nascent currents induced in the annular ferromagnetic part 22 of rotor 2. These induced currents, because of low electric resistance presented to them in this ferromagnetic part 22, have a considerable intensity and, according to Lenz's law, flow in such a direction that, by their effects, they oppose the change in magnetic flux which dictates the direction, namely the rotational movement of rotor 2. The stronger the magnetic field generated by the coils of inductor 13, the stronger the induced currents, known as eddy currents, and in turn generate an inversely strong magnetic field with the effect of decelerating, and finally of braking, the rotor more quickly.

The electromagnetic retarder according to the invention also comprises a first shaft 3 configured at least one of its two ends, which are respectively numbered 31 and 32 in such a way that they can be coupled to the corresponding shaft, that is to say to second shaft 4 linked to the motive source 6 or third shaft 5 linked to the load, in an axially sliding manner.

According to the embodiment in FIG. 4, first end 31 of first shaft 3 is configured so that second shaft 4 is received by hafting, that is to say the grooved end of second shaft 4 is hafted in the first hollow end 31 of first shaft 3. In a similar way, third shaft 5 is hafted by its grooved end in the second hollow end 32 of first shaft 3. Advantageously, first shaft 3 is constructed entirely as a hollow shaft. The second and third shafts 4, 5 are fitted in ends 31, 32 in an axially sliding manner, their respective groove ensuring assembly firmly linked in rotation between the first and second shafts on the one hand, and between the first and third shafts on the other hand.

On the entry side of the electromagnetic retarder, that is to say the side of first end 31 of first shaft 3, second shaft 4 is extended in the opposite direction relative to the section grooved by a first jaw end 41 constituting an integral section of a cardan joint 42 by which a propshaft 6 linked to a gearbox is connected to the retarder.

In a similar way, third shaft 5 comprises at its end opposite the grooved section hafted in second end 32 of first shaft 3, a jaw end 51 intended to constitute an integral section of a cardan joint 53 by which a propshaft 7 linked to driving wheels is connected to the retarder.

As the layout of the components of the retarder according to the invention, illustrated in FIG. 4, shows, the principle of the present invention is based on the fact that the function of the sliding motion of the propshaft is integrated in the shaft of the retarder, that is to say in first shaft 3. This renders the possibility of dispensing with coupling plates and thus reducing the number of parts and the weight of the powertrains comprising a retarder according to the invention. In fact the reduction in weight can be around 20 kg.

The reduction in the number of parts also brings a particular advantage when equipping vehicles originally having no retarder with a retarder according to the invention: instead of having to replace the two initial propshafts by three propshafts with a retarder according to the art prior to the invention, only one of the two original shafts is replaced. The other shaft is only adapted in such a way that it can be connected to the retarder according to the invention. Thus, the modification is cheaper and faster.

With regard to the sliding connection itself, and in particular the preferred embodiment with shafts grooved in a complementary way, it should be stated that any other type of connection ensuring both rotational solidarity of the corresponding shafts and their axial sliding motion relative to one another, also lies within the scope of the present invention.

FIG. 5 shows an alternative of the first embodiment of a retarder according to the invention. This retarder comprises a stator 1 and two rotors 2A and 2B, as well as a first shaft 3 of which only first end 31 is configured in such a way that it can receive a shaft, here shaft 4, by hafting in an axially sliding manner. Second shaft 4 is connected, by means of the cardan joint 42, to the propshaft 6 linked to the gearbox of the vehicle.

According to this alternative embodiment, second end 32 of first shaft 3 is configured in such a way that it can receive a conventional coupling with jaw end AM.

Whereas shaft 3 is mounted in stator 1 on the side of its first end 31 by means of ball bearings 24, first shaft 3 is mounted on the side of its second end 32 in the rotor by means of roller bearings 26, for example conical roller bearings intended to compensate transversal stress relative to the axial range of first shaft 3.

Whereas rotor 2 is fitted on first shaft 3 in the first embodiment, illustrated in FIG. 4, by bolts 33, rotor 2 is fitted on first shaft 3 according to the alternative embodiment illustrated in FIG. 5, by means of an end 34 immobilized on shaft 3, for example by wedging.

The electromagnetic retarder of the invention, according to a second embodiment illustrated in FIG. 6 and according to alternative embodiments illustrated in FIGS. 7 to 9, is a retarder of the Focal type mounted axially on the output shaft 4 of a gearbox B.

This retarder, as the retarder according to the first embodiment, comprises a stator 1 passed through by a first shaft 3 having a first end 31 and a second end 32, the two ends 31, 32 being axially opposed and coupled respectively to second shaft 4 and propshaft 7 linked to a load, for example to driving wheels RM. The retarder also comprises a rotor 2 assembled with first shaft 3 in order to present an internal cylindrical face 21 in the vicinity of an external cylindrical face 11 of stator 1 with a thin air-gap 12 between stator 1 and rotor 2.

In this electromagnetic retarder, first shaft 3 is configured at one of these two ends, here at first end 31, in order to be coupled to the corresponding shaft, here the output shaft 4 of gearbox B, in an axially sliding manner. For this purpose, first end 31 of first shaft 3 is configured in such a way that it can receive the second shaft by hafting. Second end 32 of first shaft 3 is configured in order to constitute a sliding flange 8 intended to receive the propshaft 7. In the versions illustrated in FIGS. 6 to 8, the sliding flange 8 comprises an integrated jaw 9 constituting an integral part of a cardan joint 52 by which the propshaft 7 is connected to the retarder.

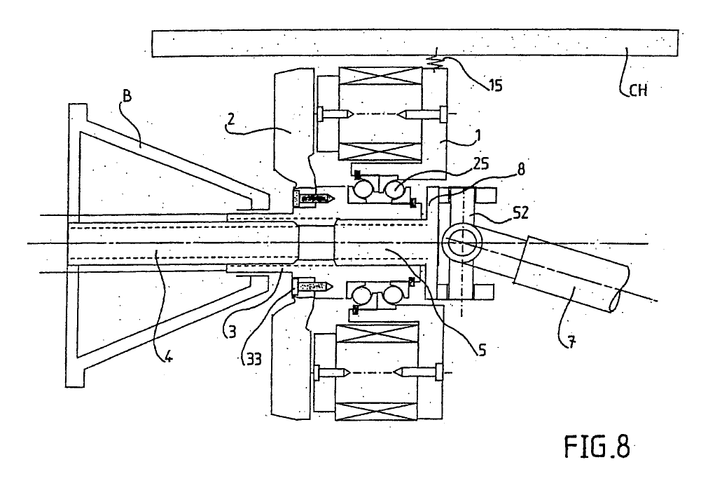

In the retarders according to the second embodiment of the invention, illustrated in FIGS. 6, 7 and 9, first shaft 3 passes through rotor 2 and is assembled in the latter both firmly linked in rotation and axially sliding. In this point it differs in particular from the axial retarders illustrated in FIG. 4, corresponding to the first embodiment of the invention, and the Focal retarder illustrated in FIG. 8, corresponding to the second embodiment of the invention, wherein first shaft 3 is linked in rotation with the rotor, but is not axially sliding relative to the rotor.

Nevertheless, the embodiments illustrated in FIGS. 6, 7 and 9 have in common that one of the two ends of the first shaft, here first end 31, is configured in such a way that it can be coupled to the corresponding shaft, for example the output shaft 4 of the gearbox B (FIG. 6) in an axially sliding manner. Owing to this design according to the invention, in particular conceived for applications such as fitting of the retarder directly to a gearbox or a final drive of a vehicle, first shaft 3 fulfils both the role of the single shaft passing completely through the retarder and presenting at its two opposite ends 31, 32 entry and exit connections necessary for its assembly in a powertrain, and the role of third shaft 5 of the first embodiment in the sense that it provides the function of the axially sliding coupling of a propshaft.

For this purpose first shaft 3 is provided with a double groove, namely an interior groove rendering the possibility of receiving, by hafting, the output shaft 4 of the gearbox B, and an external groove by which first shaft 3 is hafted in a grooved axial recess of rotor 2.

In the retarders according to the second embodiment of the invention, illustrated in FIGS. 6, 7, 8 and 9, first shaft 3 penetrates an opening located at the axial end B2 of the front section of gearbox B1 through which output shaft 4 extends from gearbox B.

According to one embodiment, a means of guiding shaft 3 is arranged in the opening located in the vicinity of the axial end of the front section B1 of the gearbox. By way of a non-restrictive example a smooth bearing such as for example a plain bearing can be used.

The retarder illustrated in FIGS. 6 to 9 is a retarder comprising a single rotor, which makes it possible to reduce the axial space required even further.

The retarder according to the second embodiment of the invention, illustrated in FIG. 6, has the advantage of reducing the axial length of the arrangement of the retarder in the vehicle. Preferably, rotor 2 surrounds the front section B1 of the gearbox B. More precisely, the internal cylindrical face 21 of the rotor which is opposite the external cylindrical face 11 of stator 1 is situated above the front section B1 of the gearbox. This front section B1 of the gearbox is located between the end B2 of the gearbox and the gearbox itself.

Preferably, to reduce the axial length of the arrangement even further, the external cylindrical face 11 of the stator is also located above the front section of the gearbox.

The device comprising these double sliding shafts makes it possible not to have sliding systems in the vicinity of the propshaft.

As illustrated in FIGS. 6, 7 and 9 first shaft 3 and second shaft 4 slide to the right of the rotor, which makes it possible to reduce the axial length while having a coupling of a length sufficient to ensure good transmission of the coupling. This is possible owing to the fact that the two shafts are arranged in a coaxial way inside the rotor, the second shaft here being surrounded by the first shaft.

In the version illustrated in FIG. 6, the retarder is fitted to the gearbox B in such a way that rotor 2 is facing towards first end 31 of shaft 3 or, in a general way, on the side intended to be facing towards the motive source to which the retarder should be connected.

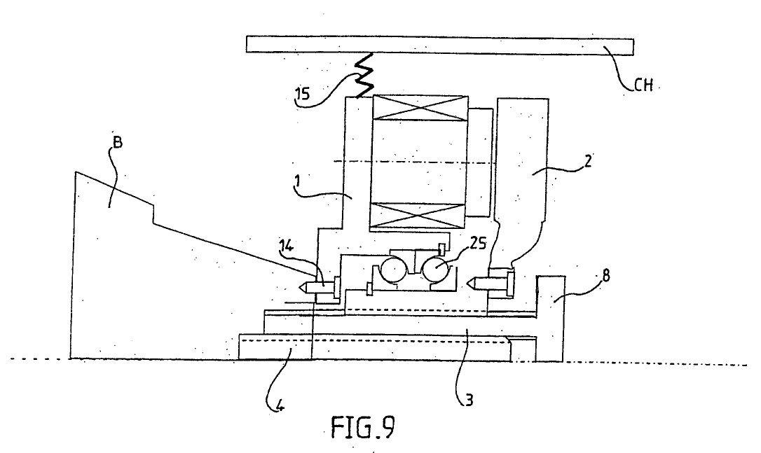

In contrast to this, in the version illustrated in FIGS. 7 and 9, rotor 2 is facing the side of end 32 of shaft 3 or, in a general manner, the side facing towards the motive source to which the retarder should be connected.

The fact of combining, in the same shaft 3, the function of the single internal shaft of the retarder and the shaft intended to be coupled to a propshaft linked to the load, has a lesser tendency, than the design according to the first mode of the embodiment, to decouple the entry and exit sides of the retarder from one another. Indeed, the design according to which first shaft 3 is connected in an axially sliding manner to two distinct shafts, ensures the integration of the retarder in the powertrain on the entry and exit side of the retarder by two connections. On the other hand, the design according to which first shaft 3 itself fulfils the function of the third shaft intended to be coupled on the entry or on the exit side to a propshaft, ensures this integration with only one connection. Consequently, any reaction emanating from the side of the driving wheels is transmitted to the shaft coming from the gearbox through only one sliding connection and thus in a more direct way than if it was transmitted through two axially independent connections.

To take account of this, the retarder according to the second embodiment comprises ball bearings 25 designed to dampen the axial forces which may act upon the gearbox.

In order not to overload the casing of the gearbox B, or possibly the casing of the final drive of the vehicle, and to avoid having to design a new casing, more robust than the casing already planned for a vehicle, the retarder is advantageously fitted on the chassis by means of a suspension 15, as illustrated in FIGS. 6, 8 and 9.

According to an alternative version illustrated in FIG. 9, the retarder is fitted, by the way of its stator and in addition the principal fixing provided by suspension 15, on the gearbox B by means of an auxiliary fitting 14 allowing the retarder to be centered on the gearbox.

While the form of apparatus herein described constitute a preferred embodiment of this invention, it is to be understood that the invention is not limited to this precise form of apparatus, and that changes may be made therein without departing from the scope of the invention which is defined in the appended claims.

What is claimed is:

1. An electromagnetic retarder to reduce the speed of rotation of a rotating machine, the retarder comprising a stator passed through by a first shaft having a first end and a second end, axially opposed, and intended to be coupled respectively to a second shaft linked to a motive source and a third shaft linked to a load, and a rotor linked in rotation with the first shaft, wherein said first shaft is configured at least one of its first end or second end in such a way that it can be respectively coupled to said second shaft or said third shaft in an axially sliding manner.

2. The electromagnetic retarder according to claim 1, characterized in that one of said first or second ends of said first shaft is configured in such a way that it can receive said second shaft by hafting and in that the other of said first or second ends is configured in such a way that it can be mounted in the third shaft by hafting.

3. The electromagnetic retarder according to claim 1, characterized in that said first end of said first shaft is configured in such a way that it can receive said second shaft by hafting.

4. The electromagnetic retarder according to claim 1, characterized in that said second end of said first shaft is configured in such a way that it constitutes a sliding flange intended to receive a propshaft connected to driving wheels.

5. The electromagnetic retarder according to claim 4, characterized in that said sliding flange comprises an integrated jaw intended to constitute an integral part of a cardan joint by which the propshaft linked to driving wheels is connected to the retarder.

6. The electromagnetic retarder according to claim 1, characterized in that said first shaft passes through said rotor and is assembled in the latter both firmly linked in rotation and axially sliding.

7. The electromagnetic retarder according to claim 1, characterized in that it comprises a rotor with single disc.

8. The electromagnetic retarder according to claim 7, characterized in that said rotor is arranged on the side of the first end of the first shaft.

9. The electromagnetic retarder according to claim 7, characterized in that said rotor is arranged on the side of the second end of the first shaft.

10. The electromagnetic retarder according to claim 1, characterized in that said rotor is assembled so as to rotate in said stator by means of a bearing intended in addition to dampen any axial forces likely to act upon said gearbox.

11. The electromagnetic retarder according to claim 10, characterized in that said bearing is a ball bearing.

12. The electromagnetic retarder according to claim 1, characterized in that said stator is fitted on the gearbox by means of an auxiliary fitting in addition to a principal fixing of the retarder on a chassis of a vehicle.

13. The electromagnetic retarder according to claim 1, characterized in that said first end of said first shaft is configured in such a way that it can receive said second shaft by hafting and in an axially sliding manner.

14. The electromagnetic retarder according to claim 1, characterized in that said second end of said first shaft is configured in such a way that it can receive said third shaft by hafting and in an axially sliding manner.

15. The electromagnetic retarder according to claim 1, characterized in that said second and/or said third shaft are hafted respectively in the first end and the second end, respectively, of said first shaft and in that each is provided with a jaw end intended to constitute an integral section of a cardan joint by which respectively said propshaft linked to the gearbox and said propshaft linked to driving wheels is connected to the retarder.

16. The electromagnetic retarder according to claim 13, characterized in that said rotor is assembled so as to rotate in said stator by means of a ball bearing.

17. The electromagnetic retarder according to claim 13, characterized in that said rotor is fixed on said first shaft by means of bolts.

18. The electromagnetic retarder according to claim 1, characterized in that said first shaft is configured at one of its first or second ends in such a way that it can be coupled to a corresponding shaft in an axially sliding manner and provided at the other of its two ends with a coupling plate making it possible to fix a propshaft thereto.

19. The electromagnetic retarder according to claim 1, characterized in that said second shaft is a gearbox output shaft.

20. A motor vehicle having a gearbox and an output shaft of this gearbox as a motive source and driving wheels as a load, wherein said vehicle comprises a retarder according to claim 1.

21. A method of installing a retarder in a motor vehicle according to claim 1, said vehicle initially having two propshafts connected to one another by a cardan joint, characterized in that one of the two original propshafts is replaced and in that the other is adapted so that it can be connected to a retarder

22. The electromagnetic retarder according to claim 6, characterized in that said second shaft is a gearbox output shaft.
